(19) United States
(12) Patent Application Publication
(10) Pub. No.: US 2016/0214298 A1
(43) Pub. Date: Jul. 28, 2016

(54) Undercut Process

(71) Applicant: Coastal Pet Products, Inc., Alliance, OH (US)

(72) Inventors: Kirk Dixon, Claremore, OK (US); David Price, Miami, OK (US)

(21) Appl. No.: 14/605,528

(22) Filed: Jan. 26, 2015

(51) Int. Cl. B29C 45/44

(52) U.S. Cl. CPC B29C 45/4407; B29K 2101/12

(57) ABSTRACT

A process of injection molding an item with an undercut. The process comprises injecting thermoplastic material into a mold, where the mold comprises a first half and a second half, where the first half has an undercut, and where the second half is offset at the undercut such that a thick area of thermoplastic is formed at the undercut, where the thick area of thermoplastic is thicker than adjacent areas of thermoplastic; cooling the thermoplastic until the thermoplastic is set everywhere except the thick area and the thick area has set edges and a molten core; removing the thermoplastic from the mold; allowing the thick area of thermoplastic to deform as it is removed from the mold such that it may be removed from the undercut; and allowing the thick area to return to its molded shape after being removed from the mold

### CROSS REFERENCE

Not Applicable.

### BACKGROUND OF THE INVENTION

1. Field of the Invention

This invention relates generally to an injection molding process, and more particularly, but not by way of limitation, to a method of injection molding an undercut on a product.

2. Description of the Related Art.

Plastic products are frequently made using injection molding, whereby heated thermoplastic is injected into a mold, cooled, and removed from the mold. It is important that the mold cavity be shaped such that the molded part may be removed from the mold. Thus, the cavity cannot angle or overhang relative to the face from which it will be removed. This presents a problem for products with an undercut feature.

Generally, an undercut cannot be made using a single pull mold. Some extra component of the mold must be included, typically called a side pull or side action. Thus, the halves of the mold are opened, the extra component is removed, and the part is removed from the mold. This extra component increases the cost and the complexity of the molding process.

Another option is to machine an undercut after the part is molded. Again, this increases the cost and complexity of producing the product.

The Applicant is the manufacturer of the animal scratching pad and amusement devices shown in U.S. Pat. Nos. 5,269,261 and 8,418,657. As set forth therein, the amusement devices include a continuous circular track in the form of a channel surrounding a scratch pad. A ball is contained within and is movable around the track. The track is arcuate in cross-section, and has a continuous longitudinal opening along the entire length of the track, positioned at the top of the device so that it is accessible. The longitudinal opening is wide enough for the paw of a cat to easily fit therethrough, allowing the cat to push or stroke the ball during use.

The width of the longitudinal opening is slightly smaller than the diameter of the ball, allowing the ball to roll around and move freely within the track without being easily removed from the track through the opening. To achieve this shape, an undercut is required.

Based on the foregoing, it is desirable to provide a process of injection molding a plastic part with an undercut without the use of additional components or machining

It is further desirable for this method to be particularly applicable to the manufacture of the animal scratching pad and amusement device described in U.S. Pat. Nos. 5,269,261 and 8,418,657, and similar devices.

### SUMMARY OF THE INVENTION

In general, in a first aspect, the invention relates to a process of manufacturing an item comprising: injecting thermoplastic material into a mold, where the mold comprises a first half and a second half, where the first half has an undercut, and where the second half is offset at the undercut such that a thick area of thermoplastic is formed at the undercut, where the thick area of thermoplastic is thicker than adjacent areas of thermoplastic; cooling the thermoplastic until the thermoplastic is set everywhere except the thick area and the thick area has set edges and a molten core; removing the thermoplastic from the mold; allowing the thick area of thermoplastic to deform as it is removed from the mold such that it may be removed from the undercut; and allowing the thick area to return to its molded shape after being removed from the mold. The mold may have only the first half and the second half and no additional component touching the thick area.

The item may be an animal amusement device comprising an open-topped continuous track, said track having an arcuate transverse cross-section and a ball movable around said track. The track may have an outer wall with a top lip and the thick area may be located along the top lip of the outer wall of the track, such that the outer wall angles inward at the top lip.

### BRIEF DESCRIPTION OF THE DRAWINGS

FIG. 1 is a perspective view of the injection molded part of the animal scratching pad and amusement device of U.S. Pat. No. 5,269,261;

FIG. 2 is a cross sectional view of a portion of the track thereof;

FIG. 3 is a cross sectional view of the portion of track shown in FIG. 2 being injection molded;

FIG. 4 is a cross sectional view of the portion of track partially removed from the mold;

FIG. 5 is a cross section view of the portion of track fully removed from the mold; and

FIG. 6 is a perspective view of the injection molded part of the animal scratching pad and amusement device of U.S. Pat. No. 8,418,657.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

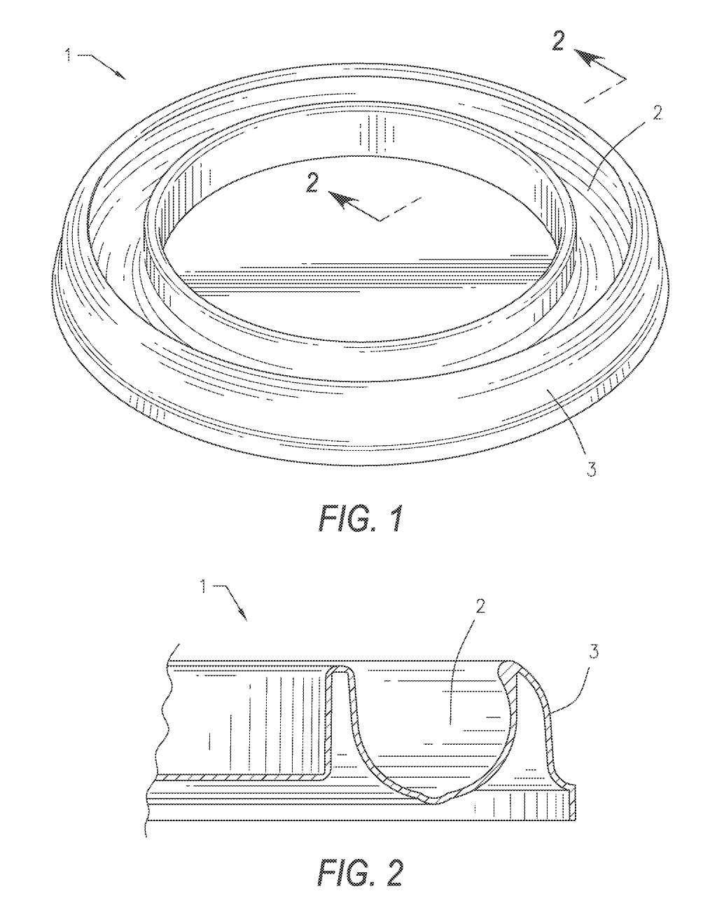

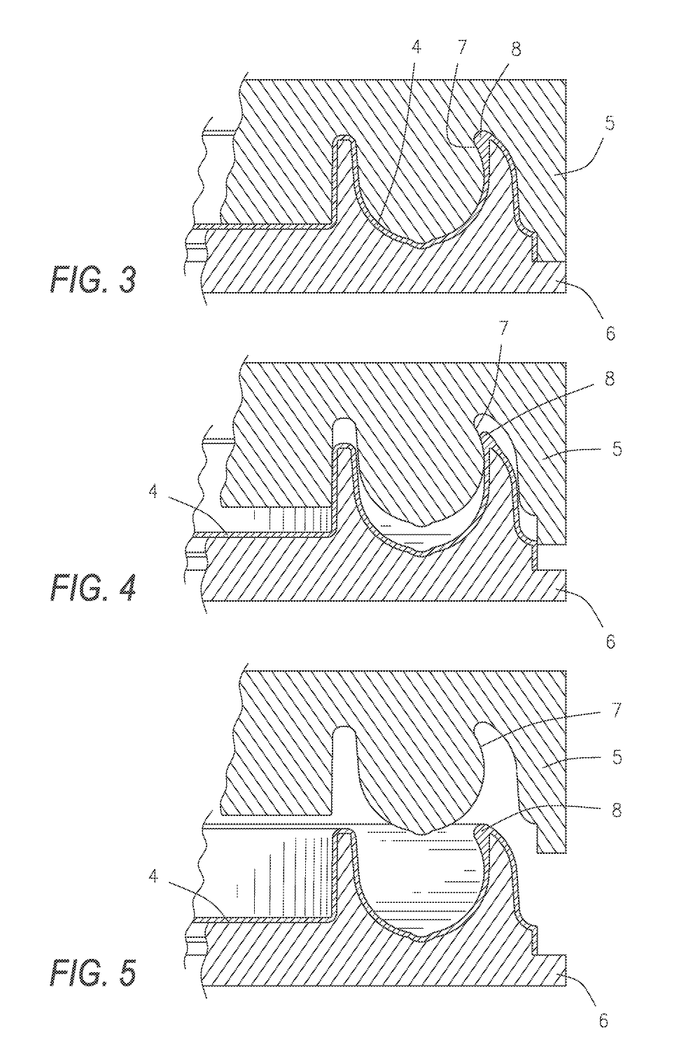

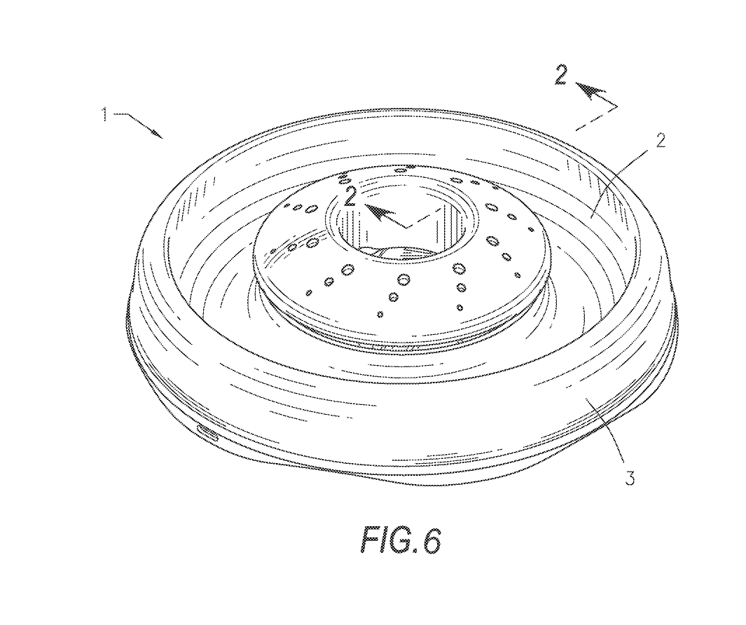

In general, in a first aspect, the invention relates to a method of injection molding a product with an undercut. This method is particularly applicable to the manufacture of the injection molded component 1 of the animal scratching pad and amusement devices of U.S. Pat. Nos. 5,269,261 and 8,418,657. This component is shown in FIGS. 1 and 6. FIG. 2 shows a cross sectional view of the track 2 of the component 1. The track 2 may have an outer wall 3, which may have an undercut to make the opening along the top of the track 2 have a smaller diameter than the rest of the track 2. This allows a ball within the track 2 to freely travel along the track 2, but be difficult to remove from the track 2 due to the smaller diameter of the opening. Component 1 is shown being molded according to the claimed method in FIGS. 3 through 5 to illustrate the method. This is not limiting, however, as the method may be used to manufacture a variety of other components with an undercut.

As shown in FIGS. 3 through 5, a molded part 4 may be high pressure injection molded using a mold with first half 5 and a second half 6. The first half 5 may include an undercut 7. The second half 6 may be offset adjacent the undercut 7 such that a thick area 8 will be formed in the molded part 4, where the thick area 8 is thicker than the surrounding areas of the molded part 4.

During molding, a thermoplastic material may be injected into a space between the first half 5 and the second half 6. The mold may be cooled just until the areas of the molded part 4 other than the thick area 8 are set, but where the thick area 8 still has a molten core with a set exterior. The molded part 4 may then be removed from the mold. The molten core of the thick area 8 may allow the thick area 8 to deform as it is removed from the undercut 7 of the first half 5, as shown in FIG. 4. It has been found that the thick area 8 will then return to its molded shape after being released from the mold, as shown in FIG. 5. Thus, an undercut may be formed in the molded part 4 without the use of additional mold components or additional machining

Whereas, the devices and methods have been described in relation to the drawings and claims, it should be understood that other and further modifications, apart from those shown or suggested herein, may be made within the spirit and scope of this invention.

What is claimed is:

1. A process of manufacturing an item comprising:
injecting thermoplastic material into a mold, where the mold comprises a first half and a second half, where the first half has an undercut, and where the second half is offset at the undercut such that a thick area of thermoplastic is formed at the undercut, where the thick area of thermoplastic is thicker than adjacent areas of thermoplastic;
cooling the thermoplastic until the thermoplastic is set everywhere except the thick area and the thick area has set edges and a molten core;
removing the thermoplastic from the mold;
allowing the thick area of thermoplastic to deform as it is removed from the mold such that it may be removed from the undercut; and
allowing the thick area to return to its molded shape after being removed from the mold.

2. The process of claim 1 where the item is an animal amusement device comprising an open-topped continuous track, said track having an arcuate transverse cross-section and a ball movable around said track.

3. The process of claim 2 where the track has an outer wall with a top lip and where the thick area is located along the top lip of the outer wall of the track, such that the outer wall angles inward at the top lip.

4. The process of claim 1 where the mold has only the first half and the second half and no additional component touching the thick area.
